(19) United States
(12) Patent Application Publication
(10) Pub. No.: US 2012/0324544 A1
(43) Pub. Date: Dec. 20, 2012

(54) INFORMATION PROCESSING APPARATUS, TERMINAL APPARATUS AND INFORMATION PROCESSING METHOD

(76) Inventor: Dai Kanetomo, Tokyo (JP)

(21) Appl. No.: 13/581,293

(22) PCT Filed: Mar. 15, 2011
(86) PCT No.: PCT/JP2011/056690

§ 371 Date: Aug. 24, 2012

(30) Foreign Application Priority Data
Mar. 19, 2010 (JP) 2010-064007

(51) Int. Cl. G06F 21/00

(52) U.S. Cl. 726/4

(57) ABSTRACT

This invention is directed to achievement of a content sharing with a high level of safety by restricting the other end of communication with which contents are shared.

An information processing apparatus, which can communicate with first and second terminal apparatuses, manages an access right required for the user of the first terminal apparatus to access contents on a network. The information processing apparatus determines whether a communication, in which the other party of communication is specified, is performed between the first and second terminal apparatuses. In the case of being determined that the first and second terminal apparatuses is performing the communication with each other, the information processing apparatus utilizes the access right to permit an access from the second terminal apparatus to the contents.

### TECHNICAL FIELD

The present invention relates to technology to share contents on a network.

### BACKGROUND ART

Technology to share contents on a network is disclosed by the patent document 1. The technology disclosed by the patent document 1 is for sharing resources for which only a session owner has an access right. To such resources, the session owner stores authentication information for accessing in a collaboration server. As a result, it becomes possible to access for a plurality of users who participate in the session.

Further, other technologies relating to the present invention are disclosed in the patent document 2 and the patent document 3. In the patent document 2, technology which certainly erases data in a memory area which is subject of return among memory areas of storage, and enables to secure security is disclosed. In the patent document 3, technology which enables limitation of operation according to shared web contents or a user is disclosed.

### PRIOR ART DOCUMENTS

### Patent Document

[Patent document 1] Japanese Patent No. 4197315
[Patent document 2] Japanese Patent Application Publication No. 2008-090643
[Patent document 3] Japanese Patent Application Publication No. 2007-193415

### SUMMARY OF THE INVENTION

### Problem to be Solved by the Invention

However, in the above-mentioned patent document 1, it admits sharing of resources to a participant in one session, but it does not mention about the relation with other communication which is separate from a resource sharing session.

Accordingly, it lacks means to confirm whether a participant in the resource sharing session is a partner to whom sharing of resources can be really permitted, and it can not be said that security is enough.

Also, even by the patent document 2 and the patent document 3, enough security cannot be secured taking into account the relation with other communication which is separate from the resource sharing session.

An object of the present invention is to provide technology which solves the above-mentioned problem.

### Means to Solve the Problem

To solve the above-mentioned problem, an apparatus according to the present invention is an information processing apparatus which can communicate with a first terminal apparatus and a second terminal apparatus comprises:

a management means for managing an access right required for a user of the first terminal apparatus to access predetermined contents on a network; and

a determining means for determining whether or not communication in which the other party is specified is being performed between the first terminal apparatus and the second terminal apparatus, wherein

the management means permits access to the contents from the second terminal apparatus using the access right in the case of being determined, by the determining means, that the first terminal apparatus and the second terminal apparatus are performing the communication.

To solve the above-mentioned problem, other apparatus according to the present invention is a terminal apparatus which can communicate with an information processing apparatus and other terminal apparatus comprises:

a means for transmitting an access right, which is required to access contents on a network from the terminal apparatus, to the information processing apparatus;

a communication means for performing communication, in which the other party is specified, with the other terminal apparatus; and

a means for transmitting a sharing request for requesting to share the contents with the other terminal apparatus to the information processing apparatus, wherein

the terminal apparatus causes the information processing apparatus to determine whether or not the communication is being performed between the terminal apparatus and the other terminal apparatus, and to permit the other terminal apparatus to access to the contents using the access right in the case of being determined that the terminal apparatus and the other terminal apparatus are performing the communication.

To solve the above-mentioned problem, a system according to the present invention is an information processing system which includes an information processing apparatus, a first terminal apparatus and a second terminal apparatus among which communication is possible, wherein

the first terminal apparatus comprises:

a means for transmitting an access right, which is required to access contents on a network from the first terminal apparatus, to the information processing apparatus;

a communication means for performing communication, in which the other party is specified, with the second terminal apparatus; and

a means for transmitting a sharing request for requesting to share the contents with the second terminal apparatus to the information processing apparatus, and

the information processing apparatus comprises:

a determining means for determining whether or not the communication is being performed between the first terminal apparatus and the second terminal apparatus; and

a management means for managing the access right, and permits access to the contents from the second terminal apparatus using the access right in the case of being determined, by the determining means, that the first terminal apparatus and the second terminal apparatus are performing the communication.

To solve the above-mentioned problem, a method according to the present invention is an information processing method using a first terminal apparatus and a second terminal apparatus which can communicate with each other comprises:

acquiring an access right required for a user of the first terminal apparatus to access contents on a network from the first terminal apparatus;

determining whether or not communication in which the other party is specified is being performed between the first terminal apparatus and the second terminal apparatus; and

permitting access to the contents from the second terminal apparatus using the access right in the case of being determined that the first terminal apparatus and the second terminal apparatus are performing the communication.

To solve the above-mentioned problem, a method according to the present invention is an information processing method using an information processing apparatus and a terminal apparatus which can communicate with other terminal apparatus comprising:

transmitting an access right, which is required to access contents on a network from the terminal apparatus, to the information processing apparatus;

performing communication, in which the other party is specified, with the other terminal apparatus; and

requesting to share the contents with the other terminal apparatus; and

causing the information processing apparatus to determine whether or not the communication is being performed between the terminal apparatus and the other terminal apparatus, and to permit the other terminal apparatus to access to the contents using the access right in the case of being determined that the terminal apparatus and the other terminal apparatus are performing the communication.

To solve the above-mentioned problem, a program embodied in a non-transitory computer readable medium according to the present invention is a program for performing information processing using a first terminal apparatus and a second terminal apparatus which can communicate with each other, which makes a computer execute:

a function for acquiring an access right required for a user of the first terminal apparatus to access contents on a network from the first terminal apparatus;

a function for determining whether or not communication in which the other party is specified is being performed between the first terminal apparatus and the second terminal apparatus; and

a function for permitting access to the contents from the second terminal apparatus using the access right in the case of being determined that the first terminal apparatus and the second terminal apparatus are performing the communication.

To solve the above-mentioned problem, a program embodied in a non-transitory computer readable medium according to the present invention is a program for controlling an information processing apparatus and a terminal apparatus which can communicate with other terminal apparatus, which makes a computer execute:

a function for transmitting an access right, which is required to access contents on a network from the terminal apparatus, to the information processing apparatus;

a function for performing communication, in which the other party is specified, with the other terminal apparatus;

a function for requesting to share the contents with the other terminal apparatus; and

a function for causing the information processing apparatus to determine whether or not the communication is being performed between the terminal apparatus and the other terminal apparatus, and to permit the other terminal apparatus to access to the contents using the access right in the case of being determined that the terminal apparatus and the other terminal apparatus are performing the communication.

### Effect of the Invention

According to the present invention, it can limit a partner of sharing contents to a communication partner who is communicating with, and it can realize contents sharing having excellent security.

### BRIEF DESCRIPTION OF THE DRAWINGS

FIG. 1 is a figure for describing a configuration of an information processing apparatus according to a first exemplary embodiment of the present invention.

FIG. 2 is a figure for describing a configuration of a system including a sharing control server according to a second exemplary embodiment of the present invention.

FIG. 3 is a flowchart showing a flow of processing in the sharing control server according to the second exemplary embodiment of the present invention.

FIG. 4 is a flowchart showing a flow of processing in the sharing control server according to the second exemplary embodiment of the present invention.

FIG. 5 is a flowchart showing a flow of processing in the sharing control server according to the second exemplary embodiment of the present invention.

FIG. 6 is a figure showing the composition of a table used in the sharing control server according to the second exemplary embodiment of the present invention.

FIG. 7 is a figure showing the composition of a table used in the sharing control server according to the second exemplary embodiment of the present invention.

FIG. 8 is a figure showing the composition of a table used in the sharing control server according to the second exemplary embodiment of the present invention.

FIG. 9 is a figure showing the composition of a table used in the sharing control server according to the second exemplary embodiment of the present invention.

FIG. 10 is a figure showing the composition of a table used in the sharing control server according to the second exemplary embodiment of the present invention.

FIG. 11 is a figure showing the composition of a table used in the sharing control server according to the second exemplary embodiment of the present invention.

FIG. 12 is a figure showing an example on a screen indicated in a terminal apparatus according to the second exemplary embodiment of the present invention.

FIG. 13 is a figure showing an example on a screen indicated in the terminal apparatus according to the second exemplary embodiment of the present invention.

FIG. 14 is a figure for describing a configuration of a system including a sharing control server according to a third exemplary embodiment of the present invention.

FIG. 15 is a flowchart showing a flow of processing in the sharing control server according to the third exemplary embodiment of the present invention.

FIG. 16 is a figure showing the composition of a table used in the sharing control server according to the third exemplary embodiment of the present invention.

FIG. 17 is a figure showing the composition of a table used in the sharing control server according to the third exemplary embodiment of the present invention.

FIG. 18 is a flowchart showing a flow of processing in the sharing control server according to the third exemplary embodiment of the present invention.

FIG. 19 is a figure showing an example on a screen indicated in a terminal apparatus according to the third exemplary embodiment of the present invention.

FIG. 20 is a figure showing an example on a screen indicated in the terminal apparatus according to the third exemplary embodiment of the present invention.

FIG. 21 is a flowchart showing a flow of processing in a sharing control server according to a fourth exemplary embodiment of the present invention.

FIG. 22 is a flowchart showing a flow of processing in the sharing control server according to the fourth exemplary embodiment of the present invention.

FIG. 23 is a hardware configuration diagram of the sharing control server according to the present invention.

### EXEMPLARY EMBODIMENT TO CARRY OUT THE INVENTION

Exemplary embodiments of the present invention will be described in detail exemplarily with reference to drawings below. However, the components indicated in the following exemplary embodiments are persistently illustration, and do not mean to limit the technological scope of the present invention to only those.

### First Exemplary Embodiment

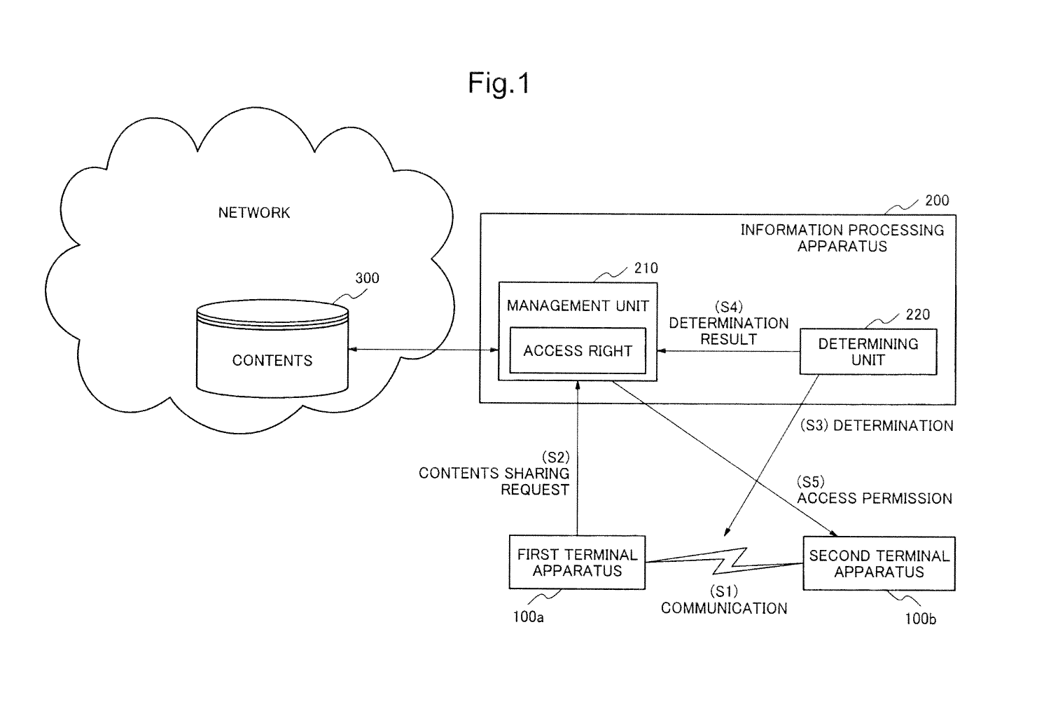

An information processing system according to the first exemplary embodiment of the present invention will be described using FIG. 1. In FIG. 1, an information processing apparatus 200 can communicate with a first terminal apparatus 100a and a second terminal apparatus 100b. The information processing apparatus 200 includes a management unit 210 and a determining unit 220. The management unit 210 manages an access right which is required for a user of the first terminal apparatus 100a to access predetermined contents 300 on a network. The determining unit 220 determines whether or not communication in which the other party is specified is being performed between the first terminal apparatus 100a and the second terminal apparatus 100b.

The management unit 210 permits access to the contents 300 from the second terminal apparatus 100b using the access right of the first terminal apparatus when the determining unit 220 determines that the first terminal apparatus 100a and the second terminal apparatus 100b are performing the specified communication.

Describing it in time series, first, the first terminal apparatus 100a and the second terminal apparatus 100b start communication in which the other party is specified (S1). The information processing apparatus 200 accepts a contents sharing request from the first terminal apparatus 100a (S2). Then, the information processing apparatus 200 determines by using the determining unit 220 whether the communication is being executed or not (S3). And, the determining unit 220 notifies the management unit 210 of the determination result (S4). In case the management unit 210 receives the determination of execution of the communication, it permits access using the access right of the first terminal apparatus 100a to the contents 300 from the second terminal apparatus 100b (S5). By this, it becomes possible for the second terminal apparatus 100b to access the contents 300.

The access right may be registered with the management unit 210 in advance, or may be requested to the first terminal apparatus 100a when a request of sharing the contents 300 is requested.

According to this exemplary embodiment, it can limit a sharing partner of contents to a communication party which is communicating with it, and it can realize the contents sharing having excellent security.

Here, although the information processing apparatus 200 functions as a server seen from the first terminal apparatus 100a and the second terminal apparatus 100b, it may include a function as a Web server simultaneously. In this case, it may be a configuration such that the information processing apparatus 200 composes a part of a network and the contents 300 themselves are stored in the information processing apparatus 200. Further, the information processing apparatus 200 may be composed of physically one apparatus, or may be a system composed of a plurality of apparatuses being combined. For example, the management unit 210 and the determining unit 220 may exist as different apparatuses.

Further, it does not matter for the means of communication mentioned above such as voice or character, as far as it is the communication in which the other party is specified. For example, the communication mentioned above may be a voice call using a session initiation protocol (SIP). In this case, for example, each of the first terminal apparatus 100a and the second terminal apparatus 100b may be a computer equipped with a call software (soft phone) which can interpret SIP or a cellular phone.

In the above description, one user is operating one terminal and is performing communication and contents sharing. However, a communication function and a contents sharing function included in the first and second above-mentioned terminal apparatuses may be divided into physically different terminals respectively. In other words, the information processing apparatus 200 may be configured so as to communicate with a plurality of terminals which one user uses. In this case, the information processing apparatus 200 may be configured so that one user, while communicating by one terminal, can share contents by other terminal.

For example, it may be configured so that a telecommunications carrier of a cellular phone manages the information processing apparatus 200. In this case, a user who is talking on the cellular phone can share contents such as documents, images and voices via the network between the users under the conversation using the present invention. For example, the user can share the highly confidential and large capacity data such as moving pictures and document files via a personal computer and the internet while talking on the cellular phone.

The information processing system according to this exemplary embodiment can limit the contents sharing between the users talking on the cellular phone. Further, when a conversation on the cellular phone finishes, the information processing system according to this exemplary embodiment can make such information sharing also finish with synchronizing. As a result, the information processing system according to this exemplary embodiment can realize the information sharing having more excellent security and high convenience.

Further, it may be configured so that the user of the first terminal apparatus 100a sends the access right to the management unit 210 from the first terminal apparatus 100a just before the management unit 210 performs the access permission (S5) to the second terminal apparatus 100b. Or, it may be configured so that the user registers the access right with the management unit 210 beforehand. After performing the access permission to the second terminal apparatus 100b, further, the determining unit 220 may determine whether or not it permits storing the contents in the second terminal apparatus 100b. This determination may be performed based on settings which have been set in advance by the user of the first terminal apparatus 100a. It may also be configured so that setting whether or not the storing is permitted is performed for each of the contents, and registered in advance together with an identifier (a URL, for example) of the contents.

The determining unit 220 determines whether communication is being performed between the first terminal apparatus 100a and the second terminal apparatus 100b. At that time, when the information processing apparatus 200 can connect to a dedicated apparatus which manages the communication, the determining unit 220 may access and inquire of the apparatus. Or, it may directly inquire of at least any one of the first terminal apparatus 100a and the second terminal apparatus 100b.

According to this exemplary embodiment, although the communication between two parties as the first terminal apparatus 100a and the second terminal apparatus 100b is given as an example, the present invention is not limited to this. It is also possible to apply to a form which performs information sharing via the internet while performing communication with three or more parties in such as a telephone conference system or a video conference system.

### Second Exemplary Embodiment

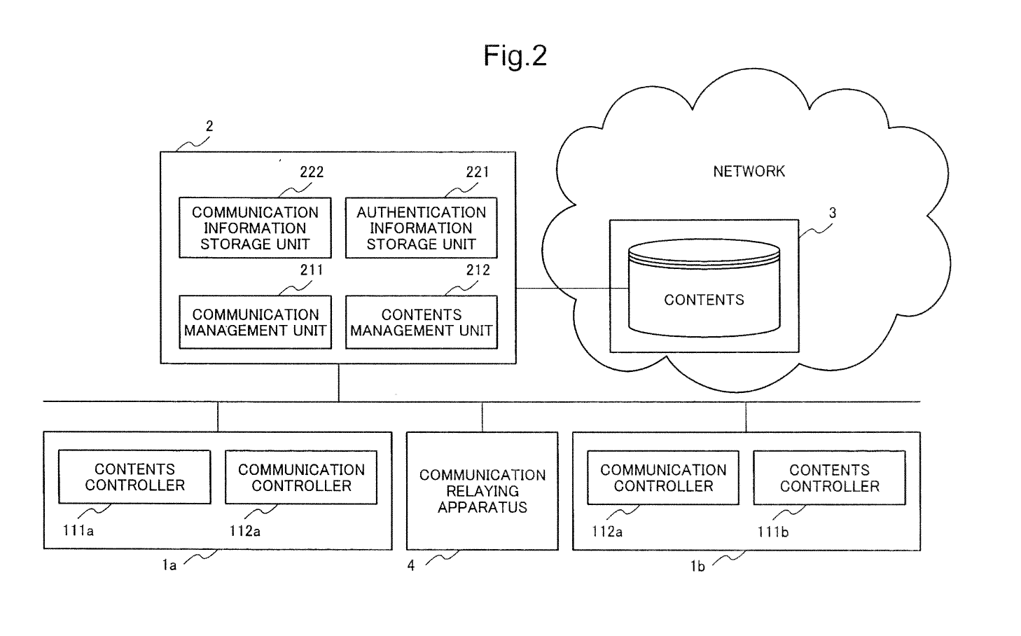

A sharing control server 2 as an information processing apparatus according to the second exemplary embodiment of the present invention will be described in detail with reference to FIGS. 2 to 7.

### [Configuration]

In FIG. 2, a sharing control server 2 is connected to terminal apparatuses 1a and 1b, a Web server 3 and a communication relaying apparatus 4. The terminal apparatus 1a includes a contents controller 111a and a communication controller 112a, and the terminal apparatus 1b includes a contents controller 111b and a communication controller 12b. The sharing control server 2 includes a communication management unit 211, a contents management unit 212, an authentication information storage unit 221 and a communication information storage unit 222. The communication here is performed by a session which is different from a session to be established for sharing contents. In other words, the session for sharing contents is established apart from the session for communication.

Further, the sharing control server 2 corresponds to the information processing apparatus 200 in FIG. 1, and the communication management unit 211, the contents management unit 212, the authentication information storage unit 221 and the communication information storage unit 222 correspond to the management unit 210 and the determining unit 220 as a whole. The terminal apparatus 1a and the terminal apparatus 1b correspond to the first terminal apparatus 100a and the second terminal 100b in FIG. 1 respectively.

In the contents controller 111a, it specifies contents which a user A intends to share with a user B by a URL. The contents controller 111a receives the contents transmitted from the Web server 3 via the sharing control server 2. Further, a user inputs authentication information in the contents controller 111a when it is required. The communication controller 112a connects with the communication controller 112b of the terminal apparatus 1b according to designation of a partner by a user, and enables the communication between the user and other user. Communication may be performed directly between the communication controllers 112a and 112b, or may go through at least one or more communication relaying apparatus 4. FIG. 2 indicates an example that it goes through one set of the communication relaying apparatus 4.

The sharing control server 2 connects with the terminal apparatuses 1a and 1b which are in communication and at least one or more Web server 3, and enables the terminal apparatuses 1a and 1b to share the contents which the Web server 3 provides. In FIG. 2, it shows an example of one Web server 3, however, the contents to be shared during communication may be provided by a plurality of Web servers. The communication management unit 211 manages the state of the communication session between the terminal apparatuses 1a and 1b which intend to share the contents of the Web server 3. The communication management unit 211 stores information relating to the communication session in the communication information storage unit 222. The contents management unit 212 communicates with the Web server 3 in order to acquire the contents which are specified in the contents controller 111a of the terminal apparatus 1a which is in communication. The contents management unit 212 which has acquired the contents from the Web server 3 transmits the acquired contents to the contents controller 111b with which they are shared. When authentication by the Web server is required at the time of acquiring contents from the Web server 3, the contents management unit 212 uses the authentication information stored in the authentication information storage unit 221. When available authentication information does not exist in the authentication information storage unit 221, the contents management unit 212 requests the contents controller 111a for inputting the authentication information.

### [Specific Example of Configuration]

According to this exemplary embodiment, a general-purpose computer can be adopted as an example of the terminal apparatuses 1a and 1b. Further, as the sharing control server 2, a computer having a central processing unit, memories and hard disks can be adopted. By executing a computer program on the memory by the central processing unit, both of them function as each of components shown in FIG. 2. Moreover, a dedicated apparatus for a SIP server may be adopted as the communication relaying apparatus 4. The terminal apparatuses 1a and 1b connect with the internet through a network of an Internet Service Provider (ISP). The sharing control server 2 and the communication relaying apparatus 4 exist in the network of the ISP. It is supposed that the Web server is connected to the internet. However, the present invention is not limited to these specific examples.

### [Operation]

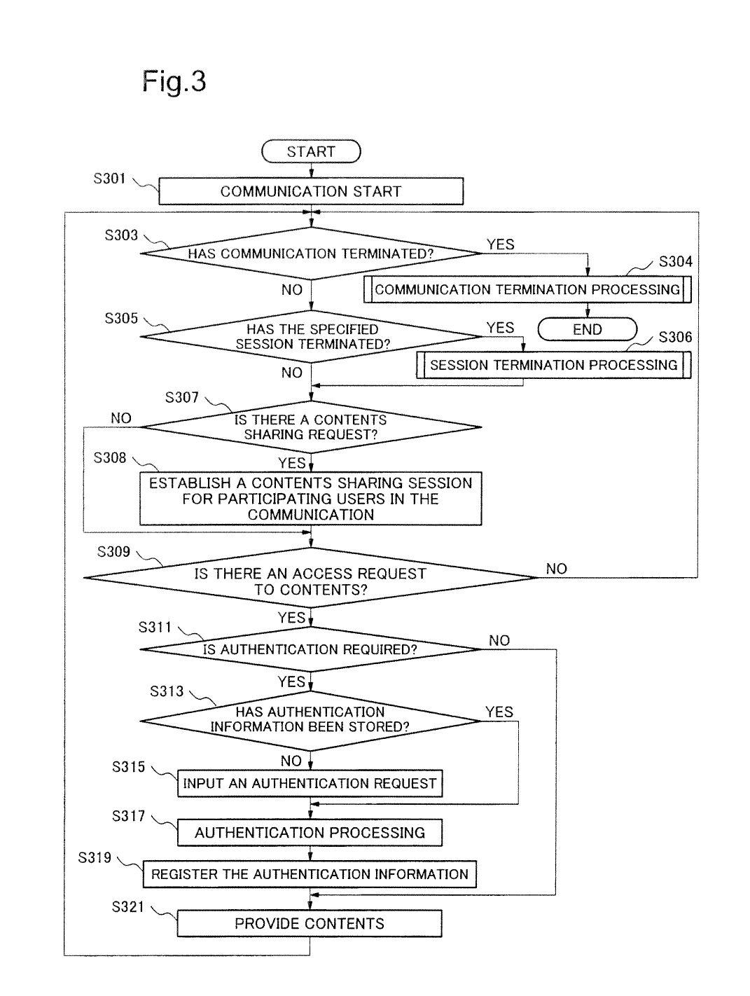

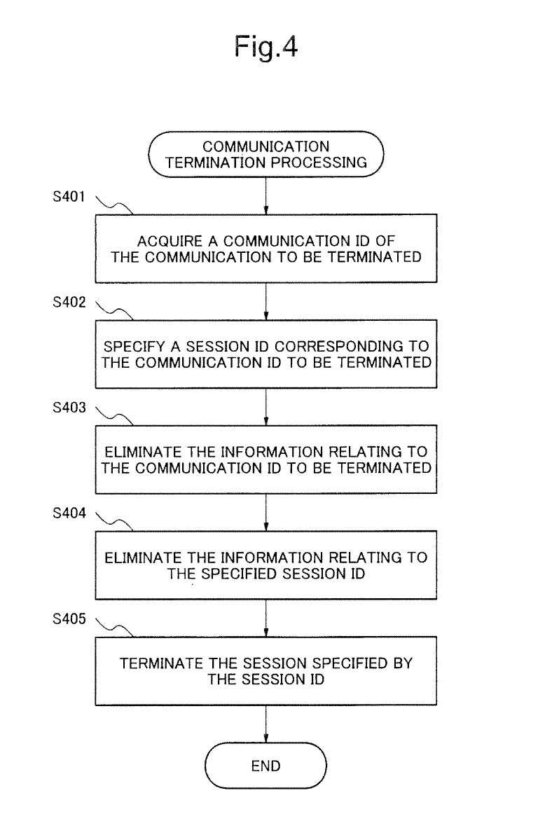

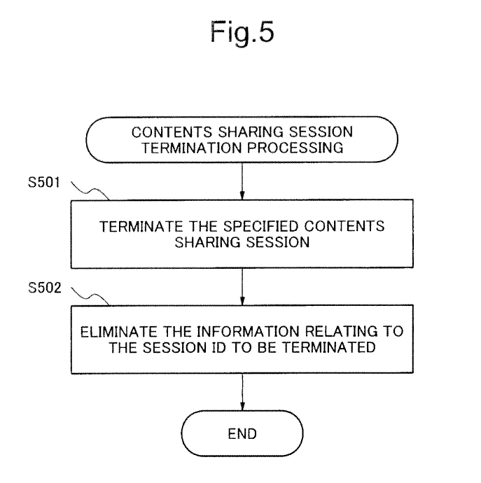

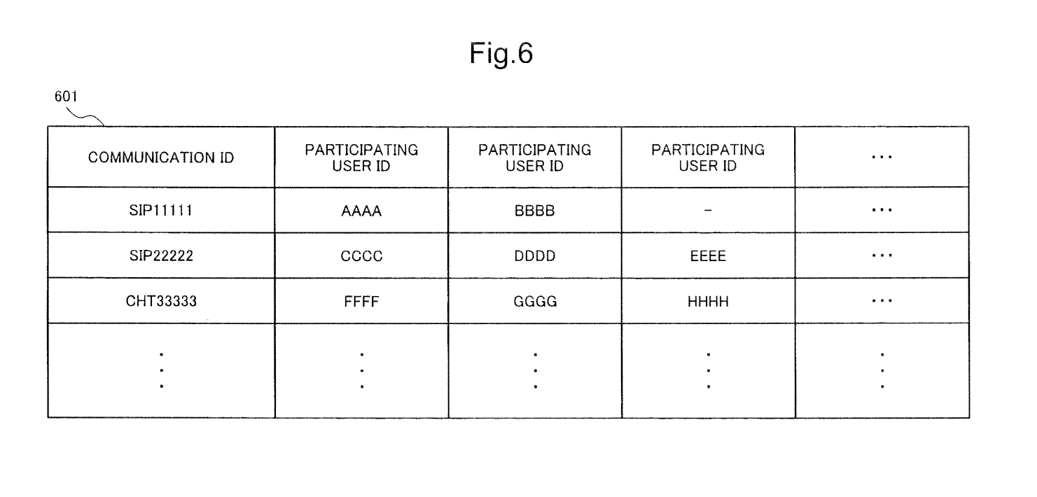

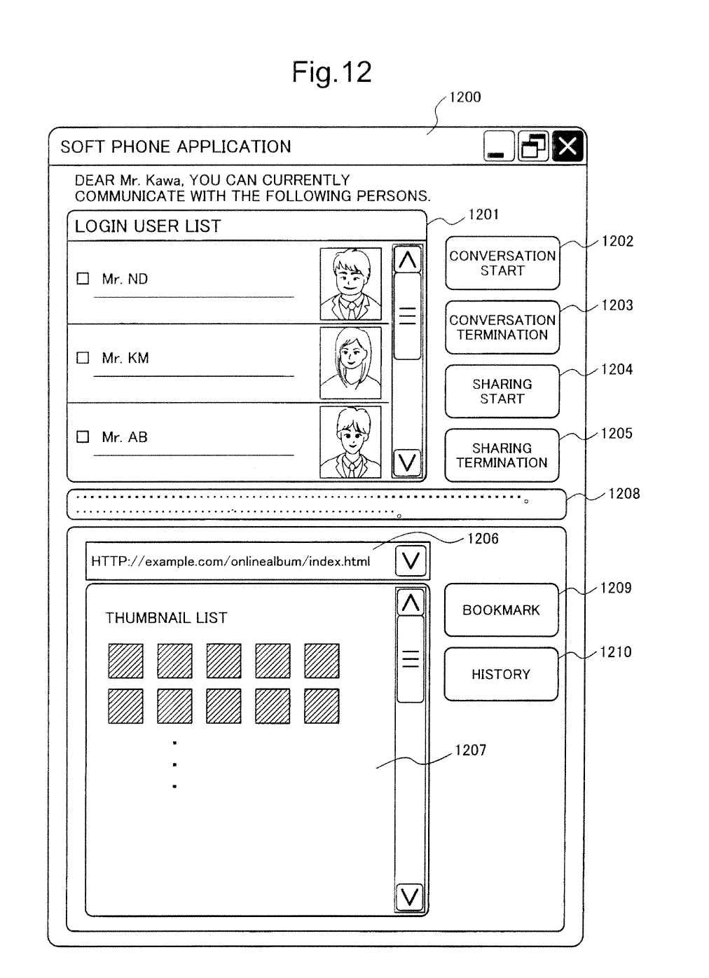

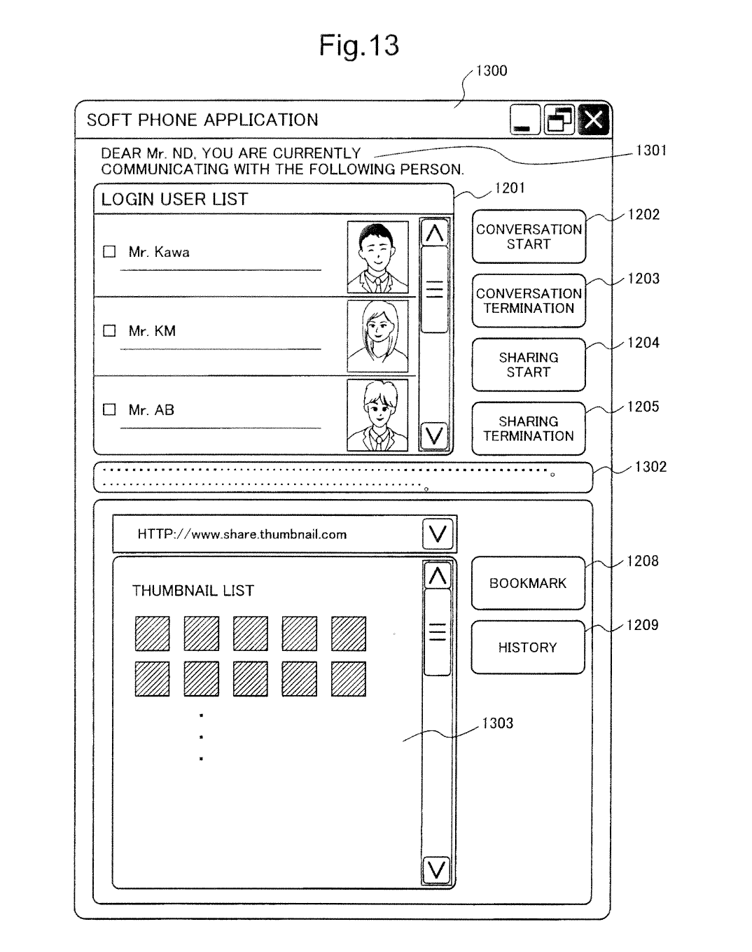

Next, operation of this exemplary embodiment will be described with reference to flow charts on FIG. 3, FIG. 4 and FIG. 5, tables on FIGS. 6 to 11, and display screens on FIG. 12 and FIG. 13.

FIG. 3 shows processing at the time of communication and contents sharing, and FIG. 4 shows operation at the time of termination of the communication. Referring to FIG. 3, the user A of the terminal apparatus 1a starts communication, using the communication controller 112a, with the user B of the terminal apparatus 1b utilizing the communication relaying apparatus 4 and the communication controller 112b (Step S301).

Next, in Step S303, the communication management unit 211 determines whether or not there exists a termination instruction of the communication which started at Step S301. The sharing control server 2 receives the termination instruction from any one of the terminal apparatuses 1a and 1b which are in communication. In case the termination instruction of the communication exists, it proceeds to Step S304, and performs the communication termination processing.

When the termination instruction of the communication does not exist, it proceeds to Step S305, and the contents management unit 212 determines whether or not there exists a termination instruction of a contents sharing session. The sharing control server 2 receives the termination instruction from any one of the terminal apparatuses 1a and 1b which have been performing the contents sharing session. In case the termination instruction of the contents sharing session does not exist, it proceeds to Step S307, and the contents management unit 212 determines whether or not there exists a contents sharing request.

In case there exists the contents sharing request in Step S307, the contents management unit 212 establishes the contents sharing session, in Step S308, for participating users in the started communication.

At that time, the communication management unit 211 acquires an identifier (a communication ID) of the started communication from the communication relaying apparatus 4 or the communication controllers 112a and 112b. And, the communication management unit 211 relates the acquired communication ID to identifiers of the participating users (participating user IDs) in the communication, and manages the information as shown in a table 601 of FIG. 6 in the sharing control server 2. The table 601 shown in FIG. 6 is stored in the communication information storage unit 222 in the sharing control server 2. As a result, the relation between the communication and the participating users becomes clear.

Thus, in the table 601 of FIG. 6, the communication IDs and the participating user IDs are being stored as the information from the communication controllers 112a and 112b or the communication relaying apparatus 4. And, the communication management unit 211 determines that the terminal apparatuses 1a and 1b are communicating with each other, if the user IDs which specify the users of the terminal apparatuses 1a and 1b are related to one communication ID in the table 601 of FIG. 6.

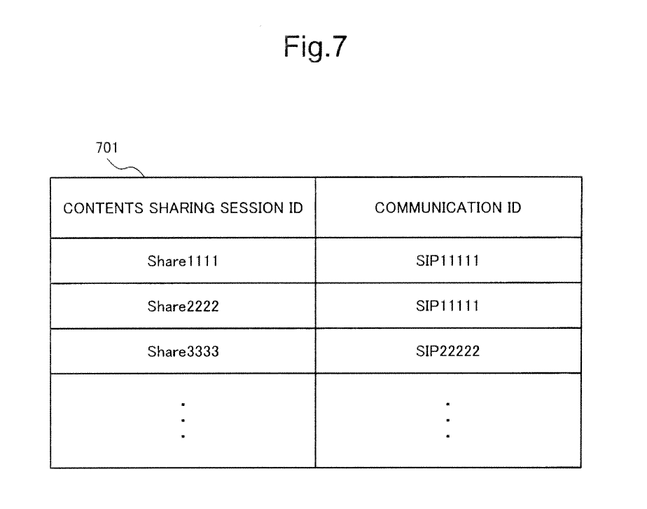

Further, the sharing control server 2 issues a contents sharing session ID, and registers with the communication information storage unit 222 by linking the contents sharing session ID with the communication ID as shown in a table 701 of FIG. 7. In other words, the sharing control server 2 manages in order to make clear the relationship which contents sharing session is for which users in communication.

Here, the participating user in the contents sharing session is limited to the user who is performing communication with the user who requested the contents sharing. For example, supposing that there is a contents sharing request from the terminal apparatus 1a during performing communication between two parties of the terminal apparatus 1a and the terminal apparatus 1b, the contents management unit 212 establishes the contents sharing session regarding the user of the terminal apparatus 1b as the session participating user.

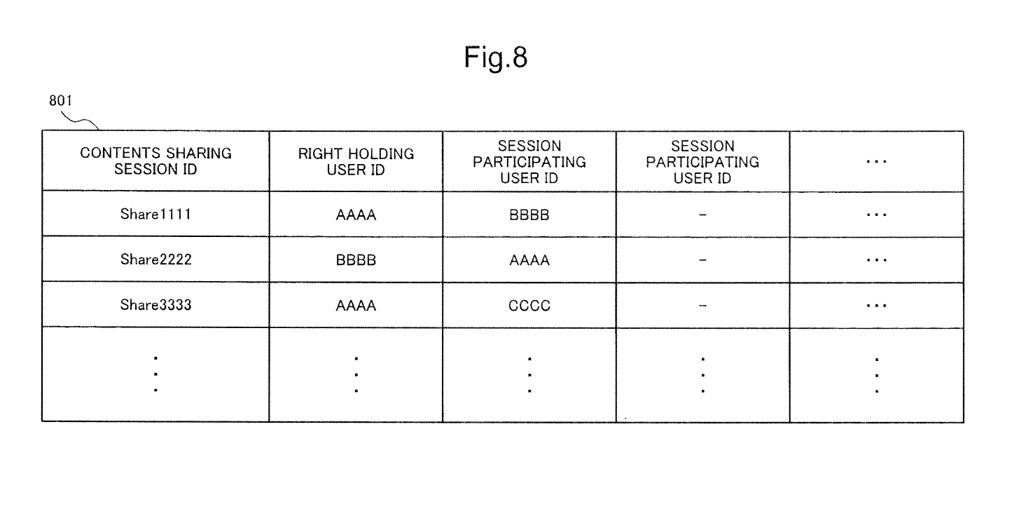

At that time, the sharing control server 2 manages the contents sharing session ID, a user ID of the user (usually, the user who requested contents sharing) who holds a right to the contents and a user ID of the participating user in the established contents sharing session like a table 801 of FIG. 8. The table 801 may be stored in the communication information storage unit 222, or it may be stored in a memory of the contents management unit 212.

The sharing control server 2 receives designation of contents as a sharing target from the terminal apparatus which performed a contents sharing request at the time of contents sharing start or after starting the contents sharing session. For example, the user A specifies contents of the sharing target by a URL in the contents controller 111a. The specified URL is transmitted to the contents management unit 212 from the contents controller 111a. Specifying by a URL may be performed by inputting the URL directly, or may be performed by clicking a link.

In case the sharing control server 2 determines that there is an access request to contents in Step S309, the contents management unit 212 accesses the Web server 3 for acquisition of the contents. And, it proceeds to Step S311 and the contents management unit 212 determines whether or not authentication is required by the Web server 3. In case the Web server 3 requests for authentication at the time of acquisition of the specified contents, it proceeds to Step S313 from Step S311, and the contents management unit 212 confirms whether information required for the authentication is stored in the authentication information storage unit 221 (Step S313).

In the case of being stored, the contents management unit 212 transmits the information to the Web server 3, and the authentication processing is performed in the Web server 3 (Step S317). In the case of not being stored, the contents management unit 212 requests the contents controllers 111a and 111b to input necessary information for the authentication (Step S315). When the user A or the user B inputs the information necessary for the authentication to the contents controller 111a or 111b, the inputted information is transmitted to the contents management unit 212.

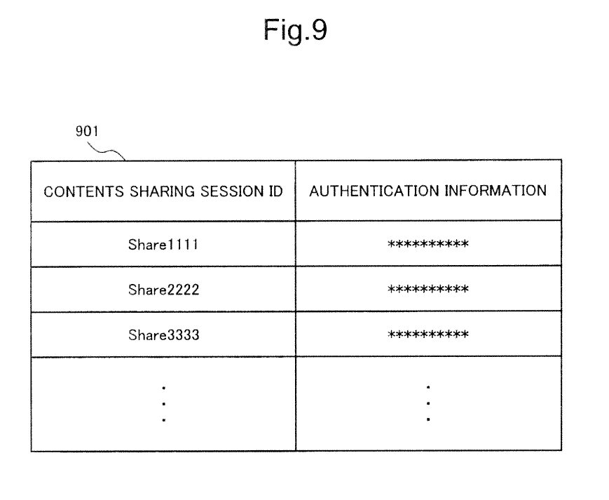

The contents management unit 212 transmits the information to the Web server 3, and the authentication processing in the Web server 3 is performed (Step S317). In case new information necessary for authentication is acquired in association with the authentication processing, the contents management unit 212 stores the information in the authentication information storage unit 221 together with the contents sharing session ID as shown in a table 901 of FIG. 9 (Step S319). The information stored in the authentication information storage unit 221 may be the information which the user inputted to the contents controller 111a or 111b, or may be the information which indicates authentication completion issued by the Web server 3 after the authentication.

In the case of determining that the authentication is unnecessary in Step S311, or in the case of succeeding the authentication processing in Step S317, the contents management unit 212 acquires the contents specified as the sharing target from the Web server 3. And, the contents are provided to the contents controllers 111a and 111b of the terminal apparatuses 1a and 1b (Step S321). In the contents controllers 111a and 111b which have received the contents, the received contents are displayed or played back.

Next, operation in a case where the user B specifies the contents and performs sharing while continuing the same contents sharing session will be described. In this case, it returns from Step S321 to Step S303, and in Step S309 through Steps S305-S308, the sharing control server 2 determines that there is an access request to the contents. When the user B specifies the contents of the sharing target by a URL, the contents management unit 212 accesses the Web server for acquisition of the contents. When the authentication processing is required to the access request of the user B (S311), the contents management unit 212 specifies the contents sharing session ID in which the user B is participating using the table 801 of FIG. 8. Because the session participating user registered with the table 801 of FIG. 8 is limited to the communication participating user registered with the table 601 of FIG. 6, accordingly, it follows that it determines whether or not the user B is the user who is in communication with the user A.

Moreover, the contents management unit 212 confirms, using the table 901 of FIG. 9, whether the authentication processing by the user A, who holds the access right, has been completed. In case the authentication information is stored on the table 901 of FIG. 9 (S313), the authentication processing is performed by the stored authentication information (S317). For this reason, even if the user B does not know the authentication information, it is possible to receive the contents provided by the contents management unit 212 (Step S321).

Next, operation at the time of communication termination and session termination will be described with reference to FIG. 4 and FIG. 5. When the communication controller 112a or the communication controller 112b terminates the communication based on an instruction from the terminal apparatus 1a of the user A or the terminal apparatus 1b of the user B, the communication management unit 211 acquires the communication ID of the communication to be terminated (S401). For this acquisition, the communication management unit 211 may inquire the state of the communication periodically to the communication controllers 112a, 112b or the communication relaying apparatus 4. Or, the communication management unit 211 may receive an event of the communication termination from the communication controllers 112a, 112b or the communication relaying apparatus 4. The communication management unit 211 takes out the contents sharing session ID linked with the terminated communication from the communication information storage unit 222 (FIG. 7), and notifies the contents management unit 212 (Step S402). At the same time, the communication management unit 211 eliminates the information relating to the terminated communication from the communication information storage unit (S403).

The contents management unit 212 which has received the contents sharing session ID eliminates the information (authentication information) relating to the contents sharing session ID from the authentication information storage unit 221 (S404), and terminates the contents sharing session (S405). Further, at the time of the session termination, the contents having been shown on the contents controller 111b may disappear, or may not disappear. On the other hand, in case only the contents sharing session is terminated while continuing communication, the processing shown in FIG. 5 is performed. In other words, the contents management unit 212 terminates the specified contents sharing session (S501). At the same time, the contents management unit 212 eliminates the information (authentication information) relating to the contents sharing session ID from the authentication information storage unit 221 (Step S502).

By adopting the configuration like this and enabling to establish a session of contents sharing for only users who are in communication at the time of starting of the contents sharing, the sharing control server 2 can realize the contents sharing having higher security. Also, it can realize the contents sharing having further higher security, because, at the time of communication termination, the contents management unit 212 also terminates the contents sharing session which is linked with the communication to be terminated, and eliminates the stored authentication information from the sharing control server.

### [Specific Example of Operation]

A specific example of the operation performed in this exemplary embodiment will be described using FIG. 2 and FIGS. 9 to 13. In this specific example, the terminal apparatuses 1a and 1b are personal computers including a display unit. The communication controllers 112a and 111b are soft phones executed on the personal computers. The contents controllers 111a and 111b are browsers which drive on the personal computers, but their operation is limited by the soft phone. When saying it conversely, it is configured such that the browser operates by a part of functions of the soft phone.

A display screen 1200 of the display unit during the soft phone being activated is shown in FIG. 12. In FIG. 12, 1201 is a display part which displays users who logged in to a network of the soft phone, and it is possible to call the user displayed here by a software manner. Further, a call start button 1202, a call finish button 1203, a sharing start button 1204 and a sharing finish button 1205 are displayed on this display screen 1200, and a request from the user is accepted respectively. Further, a message display part 1208, a URL input part 1206, a contents display part 1207, a bookmark button 1209 and a history button 1210 are prepared in the lower part of the display screen 1200, and it is configured to accept a request from the user respectively. Further, the message display part 1208 displays a message to a part where “ . . . ” is displayed in FIG. 12. The message display part 1208 displays, for example, the message like “When you start a call and sharing, you can share the data displayed below among other users in a conversation. When the call is finished, sharing of data is also finished.”

In the display screen 1200 of the soft phone on a personal computer, when the user selects at least one or more login user (a user using a personal computer which is connecting with the same ISP) from the login user list 1201, and selects the call start button 1202, the call start processing starts. This processing is the processing corresponding to Step S301 of FIG. 3, and a SIP server as the communication relaying apparatus 4 establishes a call between the users.

Here, it is supposed that a user A of the terminal apparatus 1a sent a request of call start to a user B of the terminal apparatus 1b and the user B replied to that. In this case, in the soft phone of the terminal apparatus 1b, a message 1301 during a conversation is displayed to a display screen 1300 shown in FIG. 13

Thus, while a call is being established between the user A and the user B, suppose that the user A thought to show the user A's picture on the web to the user B. In this case, for example, the user A inputs a URL of a thumbnail screen of an online album to the URL input part 1206 of the soft phone as the sharing contents. In this state, if the sharing start button 1204 on the soft phone is clicked, the soft phone conveys the information to the terminal apparatus 1b. In the soft phone (FIG. 13) of the terminal apparatus 1b, the message display part 1302 displays a message which means that a sharing request is received. For example, the message display part 1302 displays a message like “A sharing request has reached from Mr. Kawa. Access to the following link is permitted only during the call.” And, the respective soft phones connect to the sharing control server 2 according to an IP address set in advance. The sharing control server 2 inquires to the SIP server as the communication relaying apparatus 4, and confirms that two terminal apparatuses are in a voice call. The sharing control server 2 establishes a session (S308) in order that contents sharing may become possible between two soft phones.

The sharing control server 2 acquires a working communication ID (in other words, a session ID of the voice call, for example, SES-VOIP-0001) between the users A and B from the SIP server (communication relaying apparatus 4). And, the sharing control server 2 stores it inside the sharing control server 2 together with the newly given session ID (SES-SHARE-0001) of the contents sharing (FIG. 7).

The URL inputted to the URL input part 1206 of the soft phone is transmitted to the sharing control server 2, and the sharing control server 2 accesses the Web server 3. It becomes known by a login screen, which is a reply from the Web server, that user authentication is required because the online album is available to browse only for the users who have registered in advance (S311). The login screen is transmitted to the soft phones of the users A and B because the sharing control server has just started the contents sharing and it does not have necessary authentication information (S313 to S315).

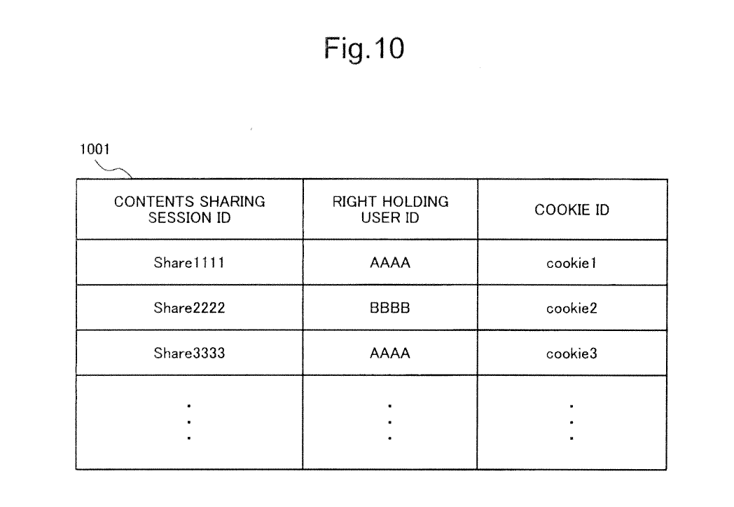

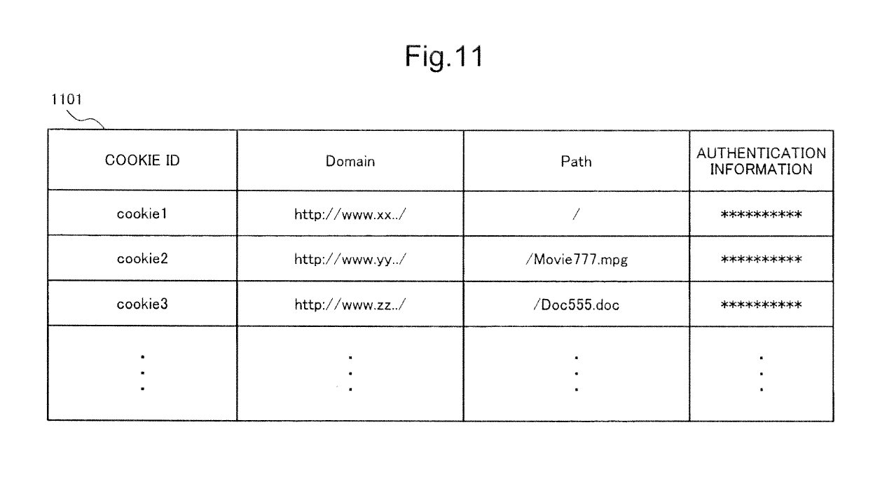

When the user A inputs an user ID and a password on the login screen, the input is transmitted to the Web server 3 via the sharing control server 2, and the authentication is performed by the Web server 3 (S317). When the user authentication has been completed, the Web server 3 issues a cookie in a reply. The sharing control server 2 which has received the reply stores the contents of the cookie as the authentication information like FIG. 10 and FIG. 11 (S319). A table 1001 of FIG. 10 is a table in which a contents sharing session and a right holding user, who has performed the user authentication, correspond to a cookie. A table 1101 of FIG. 11 is a table which shows a corresponding relationship of the domain, a pass and authentication information, which are included in the cookie.

The sharing control server 2 transmits a request including a value of the cookie to the Web server 3, acquires the contents (here, the thumbnail screen) and transmits them to the soft phone of the user B (S321). In the soft phone of the user B, the contents display part 1303 displays the received contents (1303 in FIG. 13).

Next, in case the user B clicks a link to a picture from the thumbnail screen shown in the contents display part 1303 (Step S309), a URL of the link is transmitted to the sharing control server. The sharing control server 2 determines whether or not authentication is required for the URL (S311). In case the sharing control server 2 determines that the authentication is required, it specifies an identifier (a cookie ID) of the cookie from the table 1001 of FIG. 10, and refers to the contents of the stored cookie from the table of FIG. 11. For example, suppose that the cookie corresponding to the specified URL is found in first line of the table of FIG. 11. In this case, because the values of Domain and PATH are Domain=example.com, PATH=/, the sharing control server 2 determines that it should use the stored authentication information to access the URL including example.com (Step S313). And, the sharing control server 2 transmits a request in which the stored authentication information is added to the Web server 3 (S317).

The Web server authenticates based on the value of the cookie (S137), and transmits the requested contents as a reply. The sharing control server 2 transmits the acquired contents to the soft phone of the user B (S321). As a result, sharing of contents is realized in both of the soft phones.

In case the user A or the user B selects the call finish button 1203 (Step S303), the SIP server (the communication relaying apparatus 4) notifies the sharing control server 2 of the event that the call with the communication ID of SES-VOIP-001 has been terminated. The sharing control server 2 which has received the notice determines that the corresponding contents sharing session (ID=SES-SHARE-0001) exists (S401), and eliminates the information relating to the cookie which example.com issued in the contents sharing session. And, simultaneously with this, the sharing control server 2 terminates the contents sharing session between the soft phones of users A and B (S402-S405).

According to this exemplary embodiment, it establishes the contents sharing session only limited for the users who are in communication, and it enables reuse of authentication information only limited in the contents sharing session. As a result, a user, who is recognized as a partner by the user holding the access right through communication, can acquire contents and share without stress, even if there is no access right, based on the access right of the other party of the communication. In other words, contents sharing can be performed safely and efficiently.

### Third Exemplary Embodiment

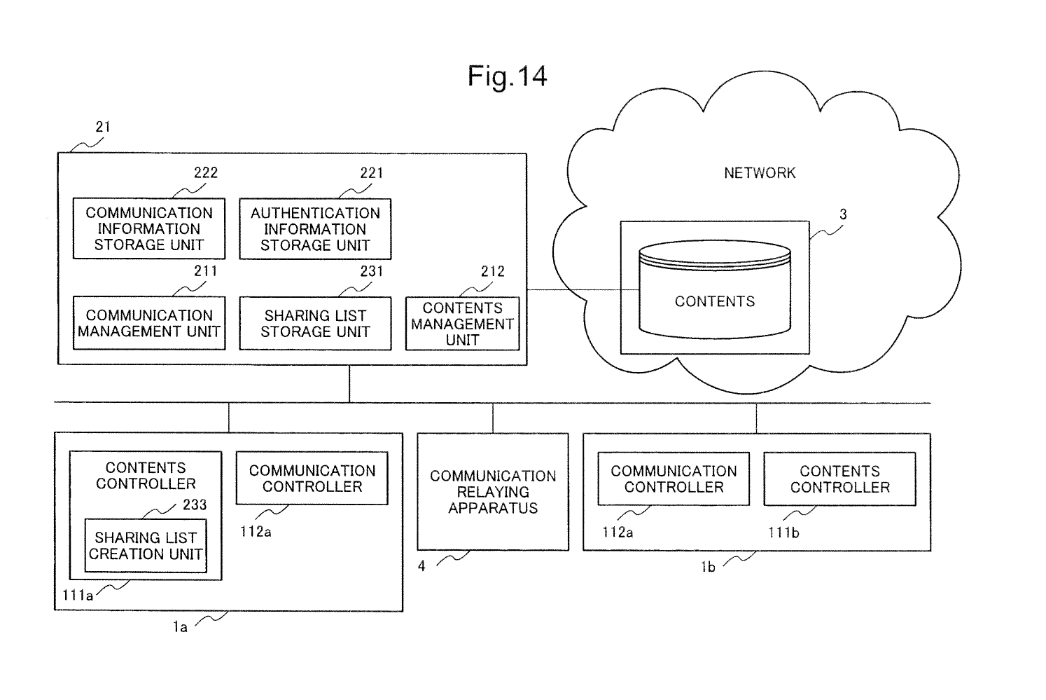

Next, the third exemplary embodiment of the present invention will be described using FIGS. 14 to 20. FIG. 14 is a figure showing the whole information processing system according to the third exemplary embodiment. In FIG. 14, a terminal apparatus 1a has a sharing list creation unit 233, and a sharing control server 21 is different from the second exemplary embodiment in a point of having a sharing list storage unit 231. The sharing list storage unit 23 corresponds to the management unit 210 in FIG. 1.

### [Configuration]

Referring to FIG. 14, the sharing list creation unit 233 creates a list of URLs (a sharing list), in the contents sharing in communication, as contents specifying information which indicates the contents which each user intends to open to a partner, and transmits to the sharing control server 21.

The contents controller 111a may support creation of the sharing list of the user. For example, it is possible to perform the processing of listing URLs of contents which are linked from Web pages. Further, the contents controller 111a can be configured to use not only a list of perfect URLs but also a regular expression as an expression form of the sharing list. The sharing control server 21 stores the sharing list and a user ID received from the terminal apparatus 1a in the sharing list storage unit 231.

The contents management unit 212 of this exemplary embodiment confirms a user ID of the user who requests contents acquisition, a user ID of the original input user of authentication information, a URL of the contents, and the sharing list. And, in case the URL of the contents in the acquisition request is included in the sharing list, the contents management unit 212 answers that it is possible to acquire the contents.

### [Operation]

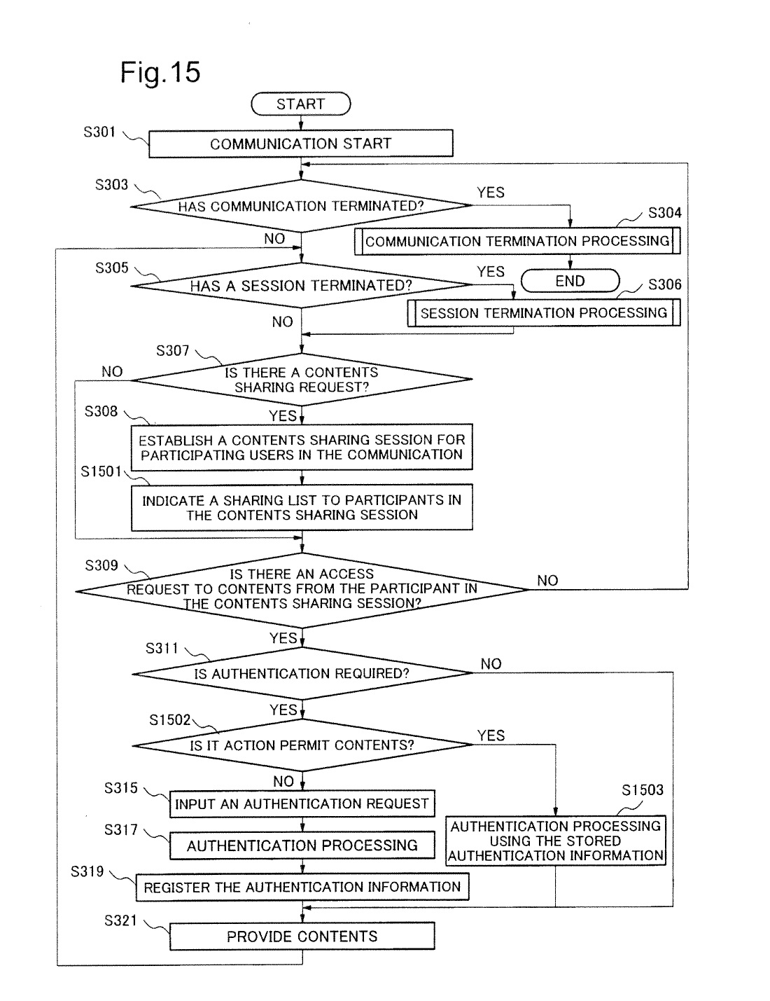

Operation of this exemplary embodiment will be described in detail with reference to FIGS. 15 to 20. Because most of the operations of this exemplary embodiment are same as the operations described in the second exemplary embodiment, to the same operations and processes, the same codes are attached and the descriptions are omitted. Specifically, in this exemplary embodiment, the processes of Steps S1501, S1502 and S1503 in FIG. 15 are different.

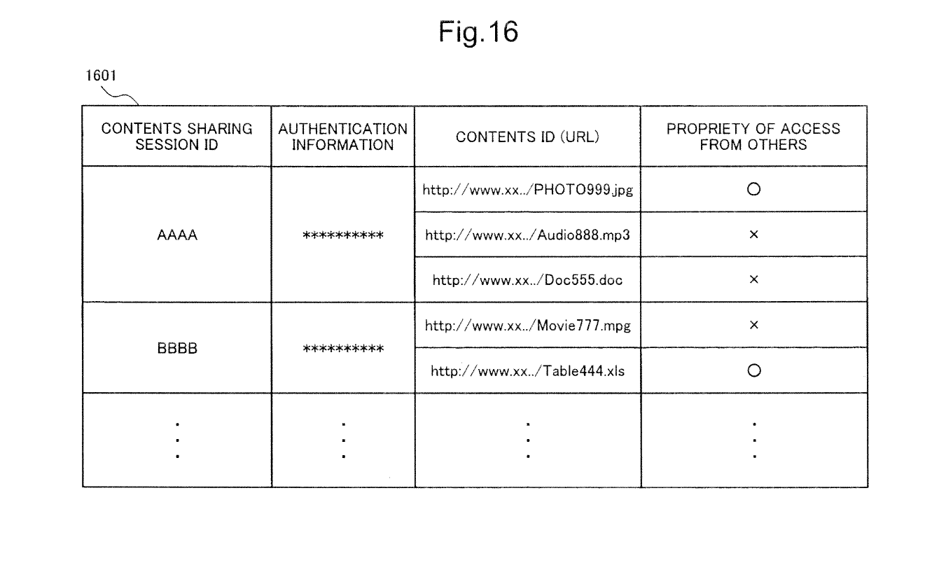

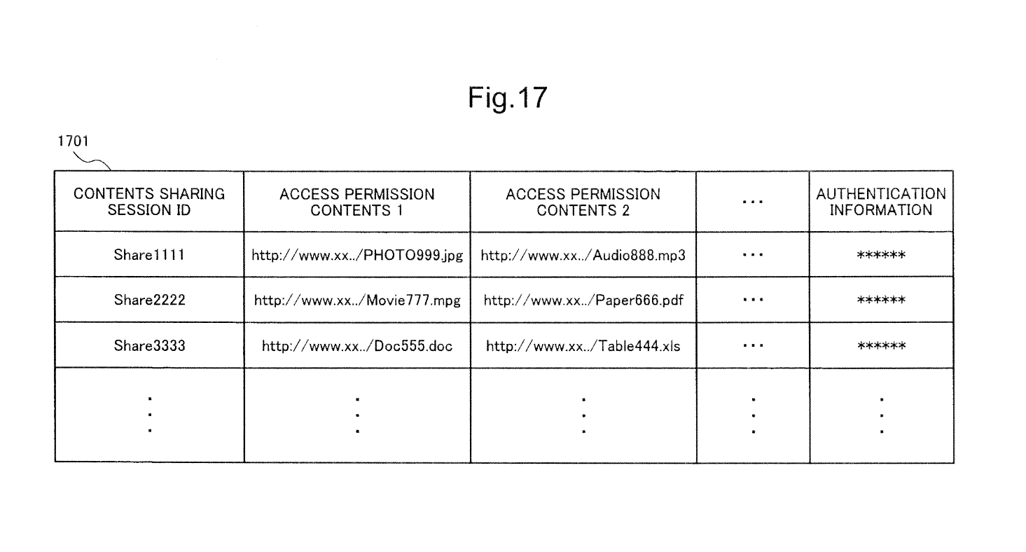

In Step S1501, after establishing a contents sharing session in Step S308, the user (a terminal apparatus) who requests contents sharing makes the sharing control server 21 transmit a list of contents access to which is permitted (hereinafter, a sharing list) to an information terminal of a participating user in the contents sharing session. The sharing list storage unit 231 stores the received list from the user who requests the contents sharing. This sharing list, after having created by the sharing list creation unit 233 before establishment of the session, may be stored in the sharing list storage unit 231 in advance like a table 1601 of FIG. 16 by being transmitted to the sharing control server 21. Or, this sharing list may be stored in the sharing list storage unit 231 at the time when requesting establishment of the contents sharing session. Or, this sharing list may be stored at any arbitrary time while the contents sharing session is being executed. In these cases, the sharing list storage unit 231 may store a URL of the sharing target contents and authentication information relating to a contents sharing session ID like a table 1701 of FIG. 17.

Even in the case of determining that the authentication processing is required for the contents for which access is requested, if the contents management unit 212 determines in Step S1502 that the contents are included in the sharing list, the contents management unit 212 determines that the authentication information is being stored. In this case, it proceeds to Step S1503 without requesting for an input of the authentication information, and the sharing control server 21 performs the authentication processing using the stored authentication information and provides the contents acquired from the Web server 3 to the user who requested the access.

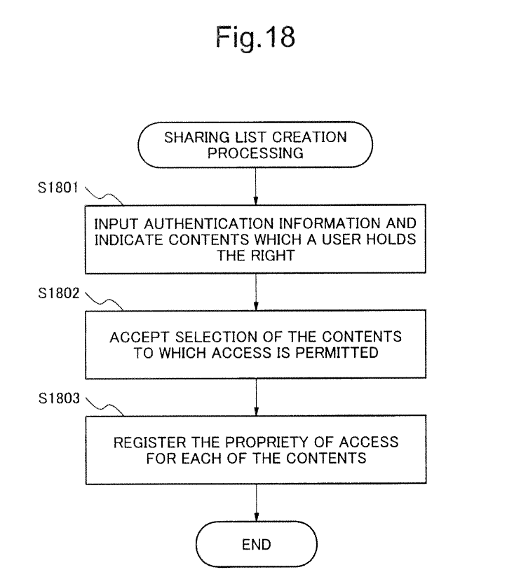

A creating operation of the sharing list is shown in FIG. 18. First, in Step S1801, the sharing control server 21 inputs authentication information, and provides the contents, the right of which is held by the user, to the information terminal. Next, in Step S1802, the sharing control server 21 receives selections of the contents which are permitted for a participant in the contents sharing session to access. And, in Step S1803, the sharing control server 21 registers whether or not access to the sharing list storage unit 231 is allowed for each of the contents as shown in FIG. 16. Although, in FIG. 16, only the propriety of access is registered, a configuration in which the propriety of storing at the time of accessing is registered simultaneously is also preferable.

### Specific Example

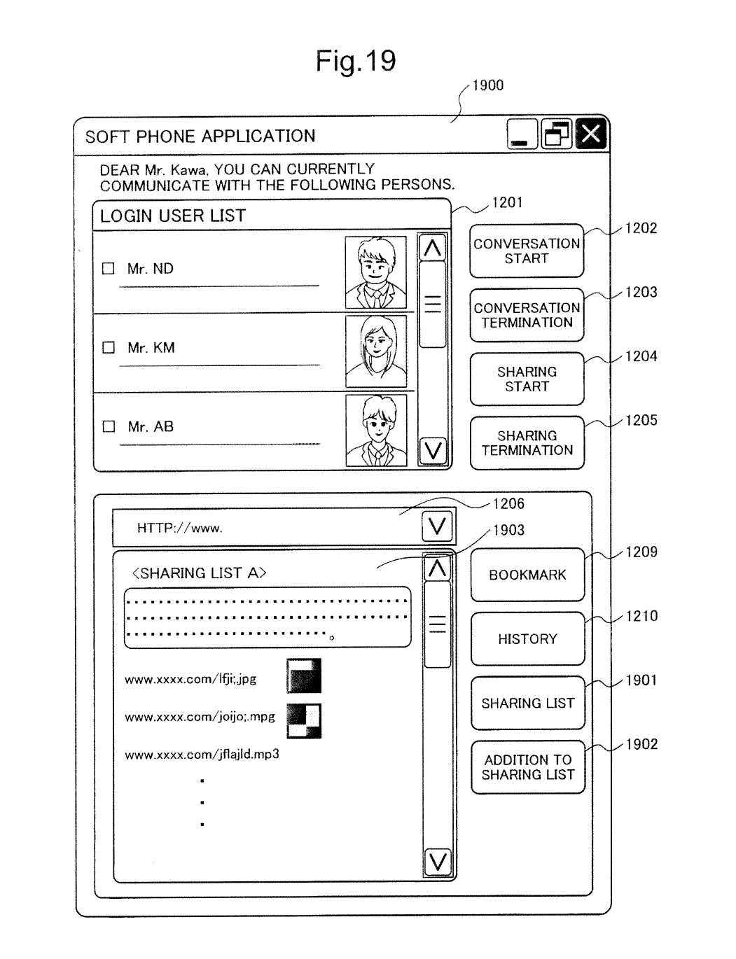

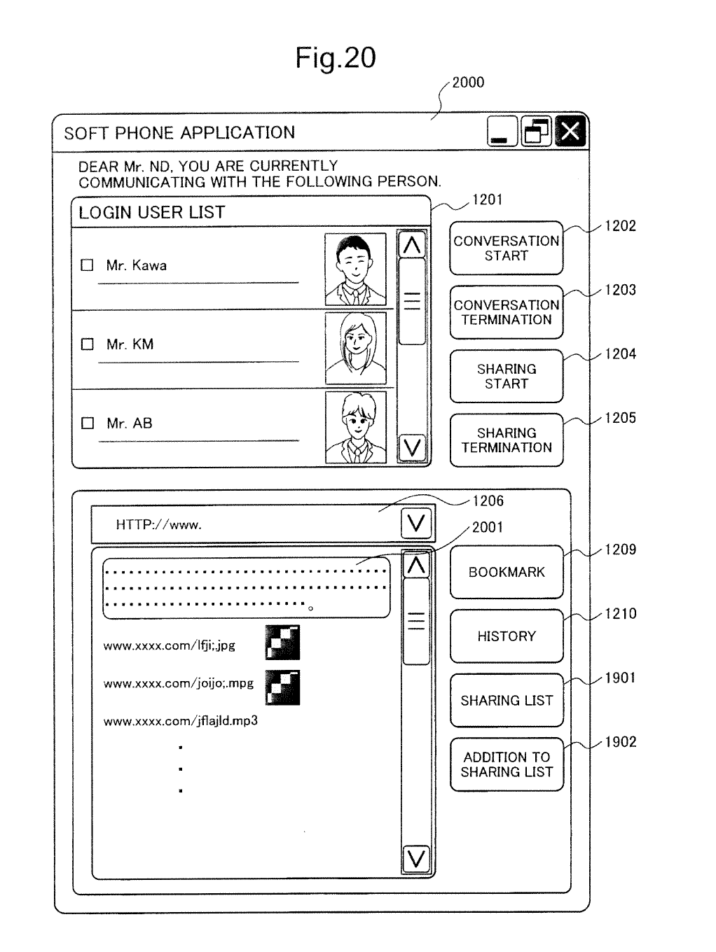

A specific example of the operation performed in this exemplary embodiment will be described using FIG. 19 and FIG. 20. In this specific example, the terminal apparatuses 1a and 1b are personal computers. The communication controllers 112a and 111b are soft phones executed on the personal computer. The contents controllers 111a and 111b are browsers which drive on the personal computers, but their operation is limited by the soft phone. When saying it conversely, it is configured such that the browser operates by a part of functions of the soft phone.

A display screen 1900 of the display unit of a user who requests the contents sharing when the soft phone is activated is shown in FIG. 19. In FIG. 19, to the elements having the same function as in FIG. 12, the same codes are attached, and the descriptions are omitted. As the points different from FIG. 12, a sharing list call button 1901, an addition to sharing list button 1902 and a contents display part 1903 which indicates the sharing list are enumerated. In case a user selects the sharing list call button 1901, the sharing list managed in the terminal apparatus 1a or the sharing control server 2 is called. On the other hand, in case the user selects the addition to sharing list button 1902, a URL indicating what is displayed on the screen at that time is added to the sharing list together with authentication information. In case the sharing list is called, the contents display part 1903 displays the selected sharing list. Also, the contents display part 1903 displays a message like “When you start sharing, access to the following links by other user in a conversation is permitted.”

On the other hand, a display screen 2000 of the display unit of the soft phone in a participant side in the contents sharing session is shown in FIG. 20. In FIG. 20, a message which means that the sharing list which is permitted to access only during a conversation is displayed in a contents display part 2001. Specifically, the contents display part 2001 displays a message like “A sharing request has reached from Mr. Kawa. Access to the following links is permitted only during a conversation.” By selecting a desired link from this sharing list and accessing, the user B of the terminal apparatus 1b can access the data for which the user A holds the right, only during a conversation, without stress.

According to this exemplary embodiment, a user having the access right can specify the contents to which access is to be permitted. And, only for the access to the contents, this exemplary embodiment allows a partner user of the communication to use the stored authentication information. Therefore, it is possible to realize sharing of contents more safely. For example, to a contents acquisition request by a user who does not have the access right, it is possible to permit the contents acquisition, using the stored authentication information, only for the contents existing in the sharing list transmitted by the user who has the access right.

### Fourth Exemplary Embodiment

Next, as the fourth exemplary embodiment of the present invention, a mechanism to share contents during communication among three or more parties will be described. Because the configuration is similar to that of the second and third exemplary embodiments, the same code is attached to the same configuration and is used for the description, here.

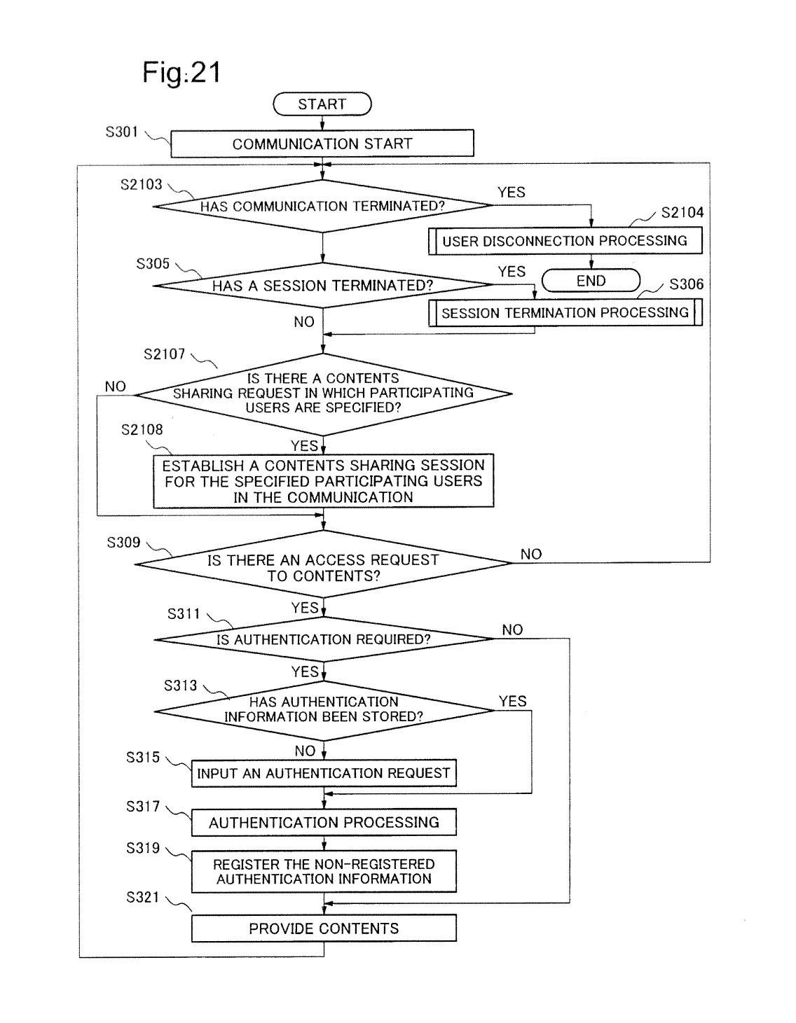

Operation will be described using a flowchart of FIG. 21. The different point from FIG. 3 used in the second exemplary embodiment is that, in Step S2107, at the time of establishing a contents sharing session, it lets a user select some users with whom the user intended to share contents among a plurality of users who participate in the communication. And, in Step S2108, the contents management unit 212 establishes the contents sharing session in which the selected users are participants.

Moreover, when only a part of participating users among a plurality of participating users of the communication request a disconnection from the communication, the sharing control server 2 performs the user disconnection processing in Step S2104.

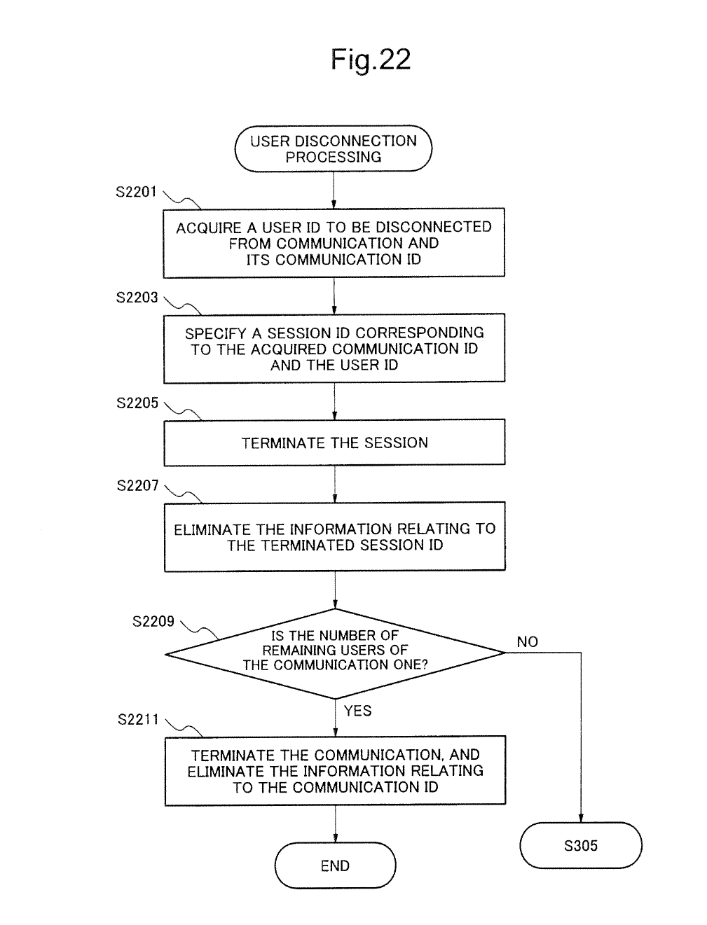

FIG. 22 is a flowchart showing a detailed flow of the user disconnection processing. In FIG. 22, first, in Step S2201, the sharing control server 2 acquires the user ID and the communication ID of the user, who is to be disconnected from the communication, from a communication relaying apparatus 4 or the like. Next, in Step S2203, the sharing control server 2 narrows down the session IDs, for example, of the table 701 shown in FIG. 7 to the session Ds corresponding to the acquired communication ID. The sharing control server 2, further, specifies the session ID corresponding to the acquired user ID using the table 801 shown in FIG. 8. In Step S2205, the sharing control server 2 terminates the session having the specified session ID. Moreover, in Step S2207, the sharing control server 2 eliminates the information relating to the terminated session ID from the table 701 of FIG. 7, the table 801 of FIG. 8, the table 901 of FIG. 9 and the table 1001 of FIG. 10 (and the table 1101 of FIG. 11 relating to that).

Moreover, in Step S2209, the sharing control server 2 determines whether or not the number of remaining participating users in the communication is one, and in case it is not one it proceeds to Step S305 of FIG. 21. In case there is one left, it proceeds to Step S2211, and the sharing control server 2 terminates the communication itself and eliminates the information relating to the communication ID, which is shown in the table 601 of FIG. 6.

As above, according to this exemplary embodiment, even if in communication among three or more, it is possible to perform sharing of contents more safely and efficiently among the participating users in the communication.

### Other Exemplary Embodiment

Although having explained in detail about the exemplary embodiments of the present invention as above, a system or an apparatus however combines the separate features included in the respective exemplary embodiments is also included as part of the present invention.

Further, the present invention may be applied to a system including a plurality of equipment, and it may also be applied to a single apparatus. Moreover, the present invention is also applicable to a case where an information processing program which realizes the functions of the exemplary embodiments is provided to a system or an apparatus directly or remotely. Accordingly, in order to realize the functions of the present invention by a computer, a program installed in the computer, or a medium which stores the program, a WWW server which makes the program download are also included as part of the present invention.

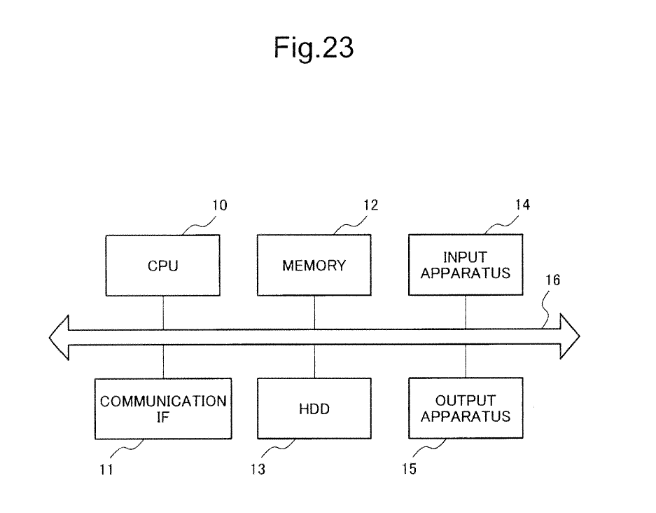

As the specific hardware configuration, for example, the sharing control server according to the present invention is realized by the configuration as shown in FIG. 23. As shown in FIG. 23, the sharing control server is realized by combination of a CPU (central processing unit) 10, a communication interface (IF) 11, a memory 12, an HDD (hard disk drive) 13, an input apparatus 14 and an output apparatus 15. These configuration elements are connected each other through a bus 16, and perform input and output of data. The communication IF 11 is an interface for connecting with an external network. The input apparatus 14 is a keyboard or a mouse, for example. The output apparatus 15 is a display or the like, for example. The sharing control server may be realized by making the CPU 10 execute a program stored in a memory medium such as the memory 12 or the HDD 13.

### Other Expression of Exemplary Embodiment

Although the whole or part of the exemplary embodiments disclosed above can be described as the following supplementary notes, the present invention is not limited to the following configuration.

### (Supplementary Note 1)

An information processing apparatus which can communicate with a first terminal apparatus and a second terminal apparatus comprising:

a management means for managing an access right required for a user of the first terminal apparatus to access predetermined contents on a network; and

a determining means for determining whether or not communication in which the other party is specified is being performed between the first terminal apparatus and the second terminal apparatus, wherein

the management means permits access to the contents from the second terminal apparatus using the access right in the case of being determined, by the determining means, that the first terminal apparatus and the second terminal apparatus are performing the communication.

### (Supplementary Note 2)

The information processing apparatus according to supplementary note 1, herein

the management means does not permit use of the access right to access from the second terminal apparatus to the contents in the case of being not determined, by the determining means, that the first terminal apparatus and the second terminal apparatus are performing the communication.

### (Supplementary Note 3)

The information processing apparatus according to supplementary note 1 or 2, wherein

the management means establishes a contents sharing session for sharing the predetermined contents between the first terminal apparatus and the second terminal apparatus and registers the access right linking with the established contents sharing session in the case of being determined, by the determining means, that the first terminal apparatus and the second terminal apparatus are performing the communication.

### (Supplementary Note 4)

The information processing apparatus according to supplementary note 3, wherein

the management means terminates the contents sharing session and eliminates the access right which is registered linking with the contents sharing session in case the communication between the first terminal apparatus and the second terminal apparatus is terminated.

### (Supplementary Note 5)

The information processing apparatus according to any one of supplementary notes 1-4, wherein

the management means registers the access right linking with the second terminal apparatus in the case of being determined, by the determining means, that the first terminal apparatus and the second terminal apparatus are performing the communication, and eliminates the access right which is registered linking with the second terminal apparatus in the case of being determined that the communication between the first terminal apparatus and the second terminal apparatus is terminated.

### (Supplementary Note 6)

The information processing apparatus according to any one of supplementary notes 1-5, wherein

the management means includes a table which registers information for specifying the second terminal apparatus as the other party of the communication of the first terminal apparatus associating with the access right held by a user of the first terminal apparatus.

### (Supplementary Note 7)

The information processing apparatus according to any one of supplementary notes 1-6, wherein

the determining means determines whether or not the communication in which the other party is specified is being performed between the first terminal apparatus and the second terminal apparatus based on information acquired from a communication control means installed in the first terminal apparatus and the second terminal apparatus respectively.

(Supplementary note 8)

The information processing apparatus according to any one of supplementary notes 1-6, wherein

the determining means determines whether or not the communication in which the other party is specified is being performed between the first terminal apparatus and the second terminal apparatus based on information acquired from a relaying apparatus which relays the communication between the first terminal apparatus and the second terminal apparatus.

### (Supplementary Note 9)

The information processing apparatus according to any one of supplementary notes 1-8, wherein

the management means receives, from the first terminal apparatus, contents specifying information which specifies contents access to which from the second terminal apparatus is permitted, and permits access from the second terminal apparatus to the contents specified by the contents specifying information using the access right in the case of being determined, by the determining means, that the first terminal apparatus and the second terminal apparatus are performing the communication.

### (Supplementary Note 10)

The information processing apparatus according to supplementary note 9, wherein

the contents specifying information is a URL where the contents are stored.

### (Supplementary Note 11)

The information processing apparatus according to any one of supplementary notes 1-10, wherein

the communication is voice communication using a session initiation protocol (SIP).

### (Supplementary Note 12)

The information processing apparatus according to any one of supplementary notes 1-11, wherein

the management means set whether or not further permits storage to the second terminal apparatus in the case of permitting the second terminal apparatus to access the contents.

### (Supplementary Note 13)

A terminal apparatus which can communicate with an information processing apparatus and other terminal apparatus comprising:

a means for transmitting an access right, which is required to access contents on a network from the terminal apparatus, to the information processing apparatus;

a communication means for performing communication, in which other party is specified, with the other terminal apparatus; and

a means for transmitting a sharing request for requesting to share the contents with the other terminal apparatus to the information processing apparatus, wherein

the terminal apparatus causes the information processing apparatus to determine whether or not the communication is being performed between the terminal apparatus and the other terminal apparatus, and to permit the other terminal apparatus to access to the contents using the access right in the case of being determined that the terminal apparatus and the other terminal apparatus are performing the communication.

### (Supplementary Note 14)

The terminal apparatus according to supplementary note 13, wherein the information processing apparatus is storing a sharing list which is a list of URLs indicating contents for each user to open to other party, and

wherein, further comprising a means which indicates the sharing list on a screen according to operation of a user.

### (Supplementary Note 15)

An information processing system which includes an information processing apparatus, a first terminal apparatus and a second terminal apparatus among which communication is possible, wherein

the first terminal apparatus comprises:

a means for transmitting an access right, which is required to access contents on a network from the first terminal apparatus, to the information processing apparatus;

a communication means for performing communication, in which the other party is specified, with the second terminal apparatus; and

a means for transmitting a sharing request for requesting to share the contents with the second terminal apparatus to the information processing apparatus, and

the information processing apparatus comprises:

a determining means for determining whether or not the communication is being performed between the first terminal apparatus and the second terminal apparatus; and

a management means for managing the access right, and permits access to the contents from the second terminal apparatus using the access right in the case of being determined, by the determining means, that the first terminal apparatus and the second terminal apparatus are performing the communication.

### (Supplementary Note 16)

An information processing method using a first terminal apparatus and a second terminal apparatus which can communicate with each other comprising:

acquiring an access right required for a user of the first terminal apparatus to access contents on a network from the first terminal apparatus;

determining whether or not communication in which the other party is specified is being performed between the first terminal apparatus and the second terminal apparatus; and

permitting access to the contents from the second terminal apparatus using the access right in the case of being determined that the first terminal apparatus and the second terminal apparatus are performing the communication.

### (Supplementary Note 17)

An information processing method using an information processing apparatus and a terminal apparatus which can communicate with other terminal apparatus comprising:

transmitting an access right, which is required to access contents on a network from the terminal apparatus, to the information processing apparatus;

performing communication, in which the other party is specified, with the other terminal apparatus; and

requesting to share the contents with the other terminal apparatus; and

causing the information processing apparatus to determine whether or not the communication is being performed between the terminal apparatus and the other terminal apparatus, and to permit the other terminal apparatus to access to the contents using the access right in the case of being determined that the terminal apparatus and the other terminal apparatus are performing the communication.

### (Supplementary Note 18)

A non-transitory computer readable medium embodying a program for performing information processing using a first terminal apparatus and a second terminal apparatus which can communicate with each other, which makes a computer execute:

a function for acquiring an access right required for a user of the first terminal apparatus to access contents on a network from the first terminal apparatus;

a function for determining whether or not communication in which the other party is specified is being performed between the first terminal apparatus and the second terminal apparatus; and

a function for permitting access to the contents from the second terminal apparatus using the access right in the case of being determined that the first terminal apparatus and the second terminal apparatus are performing the communication.

### (Supplementary Note 19)

A non-transitory computer readable medium embodying a program for controlling an information processing apparatus and a terminal apparatus which can communicate with other terminal apparatus, which makes the computer execute:

a function for transmitting an access right, which is required to access contents on a network from the terminal apparatus, to the information processing apparatus;

a function for performing communication, in which the other party is specified, with the other terminal apparatus;

a function for requesting to share the contents with the other terminal apparatus; and

a function for causing the information processing apparatus to determine whether or not the communication is being performed between the terminal apparatus and the other terminal apparatus, and to permit the other terminal apparatus to access to the contents using the access right in the case of being determined that the terminal apparatus and the other terminal apparatus are performing the communication.

While the present invention has been particularly shown and described with reference to exemplary embodiments thereof, the present invention is not limited to these exemplary embodiments. It will be understood by those of ordinary skill in the art that various changes in form and details may be made therein without departing from the spirit and scope of the present invention as defined by the claims.

This application is based upon and claims the benefit of priority from Japanese patent application No. 2010-064007, filed on Mar. 19, 2010, the disclosure of which is incorporated herein in its entirety by reference.

### DESCRIPTION OF THE CODES

1a, 1b Terminal apparatus
2, 21 Sharing control server
3 Web server
4 Communication relaying apparatus
10 CPU
11 Communication IF
12 Memory
13 HDD
14 Input apparatus
15 Output apparatus
111a, 111b Contents controller
112a, 112b Communication controller
211 Communications management unit
212 Contents management unit
221 Authentication information storage unit
222 Communication information storage unit
231 Sharing list storage unit
233 Sharing list creation unit
100a First terminal apparatus
100b Second terminal apparatus
200 Information processing apparatus
210 Management unit
220 Determining unit
300 Contents.

1. An information processing apparatus which can communicate with a first terminal apparatus and a second terminal apparatus comprising:
a management unit which manages an access right required for a user of the first terminal apparatus to access predetermined contents on a network; and
a determining unit which determines whether or not communication in which the other party is specified is being performed between the first terminal apparatus and the second terminal apparatus, wherein
the management unit permits access to the contents from the second terminal apparatus using the access right in the case of being determined, by the determining unit, that the first terminal apparatus and the second terminal apparatus are performing the communication.

2. The information processing apparatus according to claim 1, wherein
the management unit does not permit use of the access right to access from the second terminal apparatus to the contents in the case of being not determined, by the determining unit, that the first terminal apparatus and the second terminal apparatus are performing the communication.

3. The information processing apparatus according to claim 1, wherein
the management unit establishes a contents sharing session for sharing the predetermined contents between the first terminal apparatus and the second terminal apparatus and registers the access right linking with the established contents sharing session in the case of being determined, by the determining unit, that the first terminal apparatus and the second terminal apparatus are performing the communication.

4. The information processing apparatus according to claim 3, wherein
the management unit terminates the contents sharing session and eliminates the access right which is registered linking with the contents sharing session in case the communication between the first terminal apparatus and the second terminal apparatus is terminated.

5. The information processing apparatus according to claim 1, wherein
the management unit registers the access right linking with the second terminal apparatus in the case of being determined, by the determining unit, that the first terminal apparatus and the second terminal apparatus are performing the communication, and eliminates the access right which is registered linking with the second terminal apparatus in the case of being determined that the communication between the first terminal apparatus and the second terminal apparatus is terminated.

6. The information processing apparatus according to claim 1, wherein
the management unit includes a table which registers information for specifying the second terminal apparatus as the other party of the communication of the first terminal apparatus associating with the access right held by a user of the first terminal apparatus.

7. The information processing apparatus according to claim 1, wherein
the determining unit determines whether or not the communication in which the other party is specified is being performed between the first terminal apparatus and the second terminal apparatus based on information acquired from a communication control unit installed in the first terminal apparatus and the second terminal apparatus respectively.

8. The information processing apparatus according to claim 1, wherein
the determining unit determines whether or not the communication in which the other party is specified is being performed between the first terminal apparatus and the second terminal apparatus based on information acquired from a relaying apparatus which relays the communication between the first terminal apparatus and the second terminal apparatus.

9. The information processing apparatus according to claim 1, wherein
the management unit receives, from the first terminal apparatus, contents specifying information which specifies contents access to which from the second terminal apparatus is permitted, and permits access from the second terminal apparatus to the contents specified by the contents specifying information using the access right in the case of being determined, by the determining unit, that the first terminal apparatus and the second terminal apparatus are performing the communication.

10. The information processing apparatus according to claim 9, wherein
the contents specifying information comprises a URL where the contents are stored.

11. The information processing apparatus according to claim 1, wherein
the communication comprises voice communication using a session initiation protocol (SIP).

12. The information processing apparatus according to claim 1, wherein
the management unit set whether or not further permits storage to the second terminal apparatus in the case of permitting the second terminal apparatus to access the contents.

13. A terminal apparatus which can communicate with an information processing apparatus and other terminal apparatus comprising:
a unit which transmits an access right, which is required to access contents on a network from the terminal apparatus, to the information processing apparatus;
a communication unit which performs communication, in which the other party is specified, with the other terminal apparatus; and
a unit which transmits a sharing request for requesting to share the contents with the other terminal apparatus to the information processing apparatus, wherein
the terminal apparatus causes the information processing apparatus to determine whether or not the communication is being performed between the terminal apparatus and the other terminal apparatus, and to permit the other terminal apparatus to access to the contents using the access right in the case of being determined that the terminal apparatus and the other terminal apparatus are performing the communication.

14. The terminal apparatus according to claim 13, wherein
the information processing apparatus is storing a sharing list which comprises a list of URLs indicating contents for each user to open to other parties, and
the terminal apparatus further comprises a unit which displays the sharing list on a screen according to operation of a user.

15. An information processing system which includes the information processing apparatus according to claim 1, a first terminal apparatus and a second terminal apparatus among which communication is possible, wherein
the first terminal apparatus comprises:
a unit which transmits an access right, which is required to access contents on a network from the first terminal apparatus, to the information processing apparatus;
a communication unit which performs communication, in which the other party is specified, with the second terminal apparatus; and
a unit which transmits a sharing request for requesting to share the contents with the second terminal apparatus to the information processing apparatus.

16. An information processing method using a first terminal apparatus and a second terminal apparatus which can communicate with each other comprising:
acquiring an access right required for a user of the first terminal apparatus to access contents on a network from the first terminal apparatus;
determining whether or not communication in which the other party is specified is being performed between the first terminal apparatus and the second terminal apparatus; and
permitting access to the contents from the second terminal apparatus using the access right in the case of being determined that the first terminal apparatus and the second terminal apparatus are performing the communication.

17. An information processing method using an information processing apparatus and a terminal apparatus which can communicate with other terminal apparatus comprising:
transmitting an access right, which is required to access contents on a network from the terminal apparatus, to the information processing apparatus;
performing communication, in which the other party is specified, with the other terminal apparatus; and
requesting to share the contents with the other terminal apparatus; and
causing the information processing apparatus to determine whether or not the communication is being performed between the terminal apparatus and the other terminal apparatus, and to permit the other terminal apparatus to access to the contents using the access right in the case of being determined that the terminal apparatus and the other terminal apparatus are performing the communication.

18. A non-transitory computer readable medium embodying a program for performing information processing using a first terminal apparatus and a second terminal apparatus which can communicate with each other, which makes a computer operate as:
a unit which acquires an access right required for a user of the first terminal apparatus to access contents on a network from the first terminal apparatus;
a unit which determines whether or not communication in which the other party is specified is being performed between the first terminal apparatus and the second terminal apparatus; and
a unit which permits access to the contents from the second terminal apparatus using the access right in the case of being determined that the first terminal apparatus and the second terminal apparatus are performing the communication.

19. A non-transitory computer readable medium embodying a program for controlling an information processing apparatus and a terminal apparatus which can communicate with other terminal apparatus, which makes a computer operate as:
a unit which transmits an access right, which is required to access contents on a network from the terminal apparatus, to the information processing apparatus;
a unit which performs communication, in which the other party is specified, with the other terminal apparatus;
a unit which requests to share the contents with the other terminal apparatus; and
a unit which causes the information processing apparatus to determine whether or not the communication is being performed between the terminal apparatus and the other terminal apparatus, and to permit the other terminal apparatus to access to the contents using the access right in the case of being determined that the terminal apparatus and the other terminal apparatus are performing the communication.

20. An information processing apparatus which can communicate with a first terminal apparatus and a second terminal apparatus comprising:
a management means for managing an access right required for a user of the first terminal apparatus to access predetermined contents on a network; and
a determining means for determining whether or not communication in which the other party is specified is being performed between the first terminal apparatus and the second terminal apparatus, wherein
the management means permits access to the contents from the second terminal apparatus using the access right in the case of being determined, by the determining means, that the first terminal apparatus and the second terminal apparatus are performing the communication.

21. A terminal apparatus which can communicate with an information processing apparatus and other terminal apparatus comprising:
a means for transmitting an access right, which is required to access contents on a network from the terminal apparatus, to the information processing apparatus;
a communication means for performing communication, in which the other party is specified, with the other terminal apparatus; and
a means for transmitting a sharing request for requesting to share the contents with the other terminal apparatus to the information processing apparatus, wherein
the terminal apparatus causes the information processing apparatus to determine whether or not the communication is being performed between the terminal apparatus and the other terminal apparatus, and to permit the other terminal apparatus to access to the contents using the access right in the case of being determined that the terminal apparatus and the other terminal apparatus are performing the communication.
